(19) United States
(12) Patent Application Publication
(10) Pub. No.: US 2009/0097907 A1
(43) Pub. Date: Apr. 16, 2009

(54) SYSTEM FOR DETACHABLY CONNECTING MOP HEADS, MOP PADS, AND THE LIKE

(76) Inventor: Dan Blom, Paramount, CA (US)

Correspondence Address: MARC E. HANKIN, ESQ., 11414 THURSTON CIRCLE, LOS ANGELES, CA, 90049, US

(21) Appl. No.: 11/871,531

(22) Filed: Oct. 12, 2007

(51) Int. Cl. F16C 11/06

(52) U.S. Cl. 403/122

(57) ABSTRACT

Various embodiments of this invention are directed towards a system for detachably connecting a mop head to a mop handle. In various embodiments of the invention, the system comprises a ball joint and pivot cup, which is used to connect the mop head to the mop handle. The system improves upon related art systems by allowing the mop head to pivot along the handle with multiple degrees of freedom without the need for additional joints, hinges, or other such appurtenances.

### FIELD OF INVENTION

Various embodiments of this invention relate, generally, to systems for connecting mop heads, mop pads, and the like to mop handles; more particularly, to systems for detachably connecting mop heads, mop pads, and the like to mop handles.

### BACKGROUND

In the art of cleaning implement design, disposable, washable, detachable, and re-attachable cleaning heads are commonly employed in order to allow users to use cleaning heads interchangeably with a single mop handle. U.S. Pat. No. 3,827,099 to Allaire et al., for example, discloses a disposable mop head, which may be used for cleaning purposes and disposed of without the need to dispose of other portions of the mop. Such disposable mop heads are advantageous because mop heads are commonly soiled or consumed much more quickly than other portions of the mop. Thus, in this manner, new disposable mop heads may be re-attached without the expense of replacing other portions of the mop implement.

Another such design is disclosed by U.S. Pat. No. 3,593,359 to Strauss. Strauss' patent discloses a disposable head for a sweeping mop comprising a mop head with a series of straps, which allow the mop head to be detachably connected to mop handles. In order to attach the mop head to the mop handle, the user must tie the straps to one another or tie them to handle. Such attachment methods, however, are undesirable because of the time and energy required to do so. What is more, a user's hands must come into contact with the hop head, which is commonly dirty. The mop handle for systems such as Strauss' feature a joint that allows the mop head to swivel at an angle relative to the implement pole. Finally, by requiring additional parts for the swivel joint and attachment mechanism, systems such as Strauss' require additional parts and expense to manufacture.

Another such system for detachably connecting mop heads is disclosed by U.S. Pat. No. 6,948,873 to Policicchio et al. Policicchio's patent discloses a system wherein the mop head is attached using a removable pin that attaches a universal joint to the mop head. Like Strauss' system, however, Policicchio's system requires undue effort in order to attach the mop head to the mop handle and requires that the user touch the oftentimes dirty mop head with his or her hands. Furthermore, like Strauss' system, Policicchio's system requires an additional universal joint in order to facilitate the swivel of the mop head.

The swivel joints used in Strauss' and Policicchio's systems are undesirable because they only allow the mop head to swivel in one direction. Because cleaning commonly requires the user to reach tight spaces or work at unusual angles, it is desirable that the joint swivel in more than one direction. Furthermore, these systems require additional, expensive parts.

Other systems for detachably attaching devices are disclosed in patents such as U.S. Pat. No. 4,498,410 to Budge. Budge's patent discloses a ball joint and pivot cup combination for electively detachably coupling a mast to a surfboard. While Budge's system allows the mast to rotate in multiple directions and planes, it is not adaptable to mop handles and mop heads. Budge's ball joint and pivot cup are connected using a series of adjustable fasteners. If adapted to mop heads, such a system would be undesirable because of the undue effort required and the contact required with the user's hands. Furthermore, Budge fails to disclose a system whereby a mop handle could be quickly and easily attached or removed from a mop head.

Thus, in order to address these and other issues, there remains a long felt need in the art for an attachment mechanism for mop handles to mop heads, mop pads, and the like that allows the mop handle to be attached without the need for undue effort, contact with the user's hands, or additional parts and devices in order for the mop head to swivel in multiple directions relative to the mop handle.

### SUMMARY OF THE INVENTION

Various embodiments of the invention are directed towards overcoming the above shortcomings by disclosing a system for detachably connecting mop heads, mop pads, and the like to mop handles. Various embodiments improve upon the related art patents discussed above by allowing the user to attach and remove the mop head without the need for undue effort or manipulation by the user's hands. Furthermore, these various embodiments improve upon the related art devices by allowing the mop head to swivel in multiple directions without the need for additional joints, hinges, or other such undesirable parts.

In various embodiments of the invention, the system comprises a mop handle and a mop head. The mop handle may comprise any of the various materials, lengths, cross-sectional shapes, and other such types of mop handles known in the art. In various embodiments of the invention, the mop handle comprises a telescoping or extendible mop handle. The mop handle comprises a proximal end and a distal end.

The proximal end of the mop handle comprises a ball joint. The ball joint may be shaped or configured in any of the various shapes commonly used for ball joints in the art.

In various embodiments of the invention, the ball joint is configured in a spherical shape. The diameter of the spherical ball joint in various embodiments of the invention is greater than the cross-sectional diameter of the mop handle, such that the ball joint protrudes radially outwards from the mop handle. The ball joints in various embodiments of the invention are constructed of a relatively rigid material, such that they do not deform under usual working pressures. In this manner, the ball joint serves as an attachment point from the mop handle to the mop head.

In various embodiments of the invention, the system comprises a mop head featuring a pivot cup. The mop head may comprise any of the various types of mopping or cleaning devices known in the art. The mop head features a pivot cup at its top. The pivot cup is configured to feature a spherical depression such that the pivot cup fits matingly with the spherical ball joint.

The pivot cup may be constructed from any of the various plastic, rubber, or other such materials known in the art; including but not limited to polyethylene (PE), polypropylene (PP), polystyrene (PS), acrylonitrile butadiene styrene (ABS), polyethylene terephthalate (PET), polyvinyl chloride (PVC), polyurethanes (PU), polycarbonate (PC), polyvinylidene chloride (PVDC), or other such plastic materials.

In various embodiments of the invention, the pivot cup is configured to be generally less rigid in construction than the ball joint. In this manner, when the ball joint is pressured against the pivot cup, the pivot cup yields such that the ball joint is inserted into the pivot cup. Upon insertion, the pivot cup contracts in order to surround and attach the ball joint. In this manner, the ball joint and pivot cup connect matingly and are used to connect the mop handle to the mop head.

The ball joint and pivot cup attachment system disclosed by various embodiments of the invention are advantageous over the related art systems because undue effort or manipulation by the user's hands are not required in order to attach or remove the two. For example, if the mop head is placed on the floor with the pivot cup facing upwards, the mop handle may be forced onto the mop head without the need to manipulate the mop head. Furthermore, the mop head may be removed from the mop handle without the need for manipulation or contact with the user's hands. If the mop head is placed on the floor and restrained, for example by the user's shoes, the mop head may be detached from the mop handle simply by pulling up on the mop handle. In this manner, the system represents a substantial improvement on the related art patents.

Furthermore, as discussed above, several of the related art patents require joints, hinges, or other such devices in order that the mop head may pivot relative to the mop handle. These joints, hinges, or other parts are undesirable as they add additional cost and parts to the product. Also, these joints or hinges are oftentimes limited in that the mop head may only be pivoted with one degree of freedom. Various embodiments of the invention improve upon these related art systems by allowing the mop head to swivel with a great degree of freedom and 360-degrees without the need for costly, additional parts.

In various embodiments of the invention, the mop head further features one or more reinforcing flanges. The reinforcing flanges are used to keep the mop bristles facing the underside of the mop head. Furthermore, the reinforcing flanges may be used in order for the user to hold the mop head when attaching and detaching from the mop handle.

It further remains within the contemplation of the invention that it is to be used with varying types of mop handles and mop heads. Mop handles of varying lengths, materials, and types remain within the contemplation of the invention. Telescoping handles of varying types also may be used with the various embodiments of the invention. Also, the principles of the invention may be practiced with various cleaning devices other than mop heads. The principles of the invention may, for example, be practiced with household, industrial, and construction implements and their related extension handles, including but not limited to: brooms, mops, specialty mops, window squeegees, floor squeegees, window cleaners, floor sponges, window sponges, trowels, dust pans, dust mops, scrapers, bulb changers, dusters, feather dusters, brushes, carpet sweepers, and further such devices known in the art. The terms, for example, “mop head,” should not be interpreted as limiting.

### BRIEF DESCRIPTION OF THE DRAWINGS

FIG. 1 is an illustration from a side view of the detached system in various embodiments of the invention.

FIG. 2 is an illustration from a top view of the system in various embodiments of the invention.

FIG. 3 is an illustration from a cross-sectional view from the side of the system in various embodiments of the invention.

FIG. 4 is an illustration of the system, from a perspective view, while the mop handle is connected to the mop head, of various embodiments of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention. Various embodiments of the invention remain useable in tandem or combination of one another.

In the following description, certain terminology is used to describe certain features of one or more embodiments of the invention. For instance, “mop handle” refers to any of the various household, industrial, and construction handles; “mop head” refers to any mop head, mop pad, broom head, mop, specialty mop, window squeegee, floor squeegee, window cleaner, floor sponge, window sponge, trowel, dust pan, dust mop, scraper, bulb changer, duster, feather duster, brush, carpet sweeper, and further such devices known in the art.

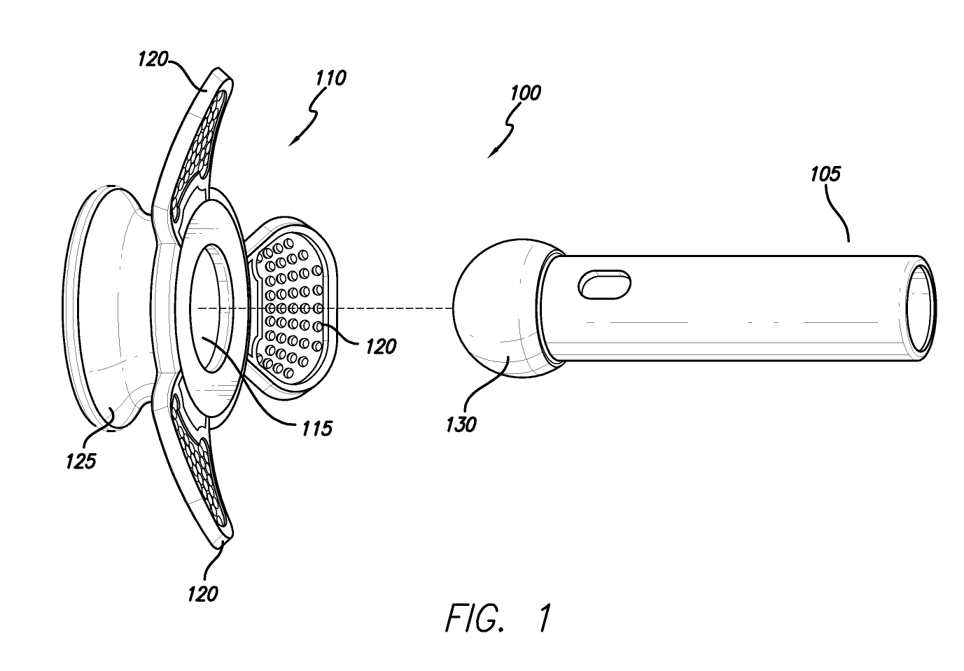

FIG. 1 is an illustration from a side view of the detached system in various embodiments of the invention. A system for detachably connecting mop heads to mop handles 100 is illustrated along with its constituent parts, including the mop handle 105 and the mop head 110. The mop handle 105 has a proximal end and a distal end. The proximal end of the mop handle 105 features a spherically shaped ball joint 110. The mop head 110 features a pivot cup 115, three reinforcing flanges 120, and a body 125 for attaching mop hairs. The ball joint 130 is configured to fit matingly to the depression in the pivot cup 115, such that when the two are attached, the mop handle 105 and mop head 110 are detachably connected to one another.

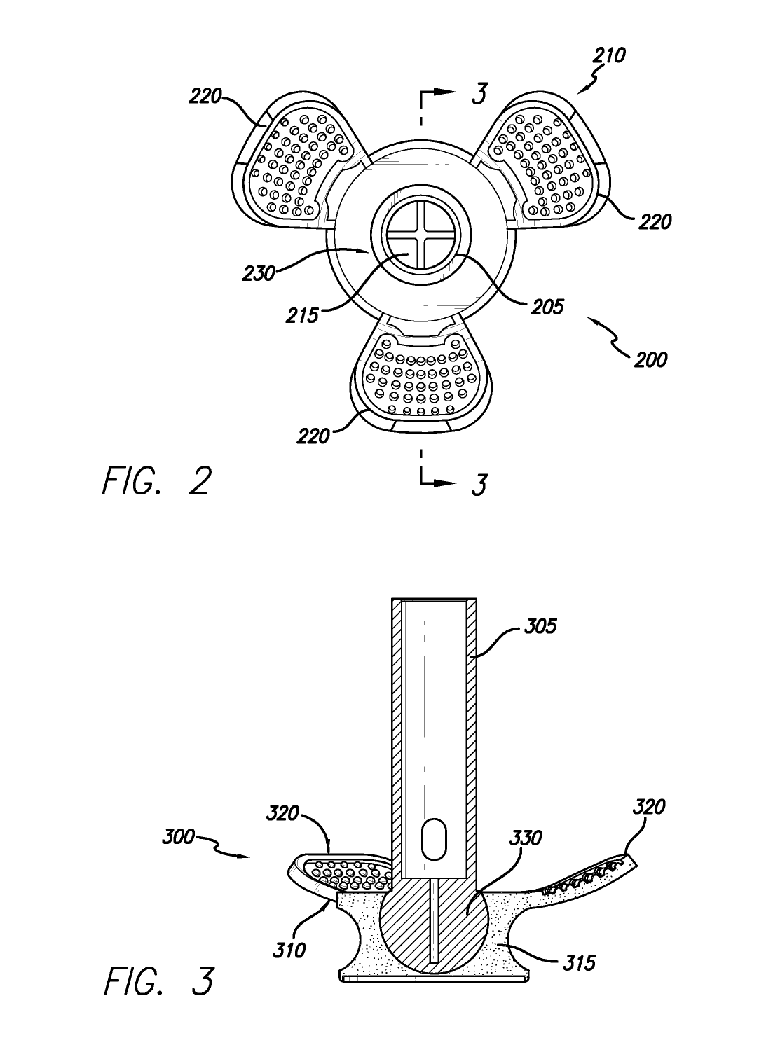

FIG. 2 is an illustration from a top view of the system in various embodiments of the invention. A system for detachably connecting mop heads to mop handles 200 is illustrated along with its constituent parts, including the mop handle 205 and the mop head 210. The mop handle 205 has a proximal end and a distal end. The proximal end of the mop handle 205 features a spherically shaped ball joint 230. The mop head 210 features a pivot cup 215 and three reinforcing flanges 220. The ball joint 230 is configured to fit matingly to the depression in the pivot cup 215, such that when the two are attached, the mop handle 205 and mop head 210 are detachably connected to one another. Further, FIG. 2 illustrates the cross section of the system for detachably connecting mop heads to mop handles 200 from which FIG. 3 is drawn.

FIG. 3 is an illustration from a cross-sectional view from the side of the system in various embodiments of the invention. A system for detachably connecting mop heads to mop handles 300 is illustrated along with its constituent parts, including the mop handle 305 and the mop head 310. The mop handle 305 has a proximal end and a distal end. The proximal end of the mop handle 305 features a spherically shaped ball joint 330. The mop head 310 features a pivot cup 315 and three reinforcing flanges 320. The ball joint 330 is configured to fit matingly to the depression in the pivot cup 315, such that when the two are attached, the mop handle 305 and mop head 310 are detachably connected to one another.

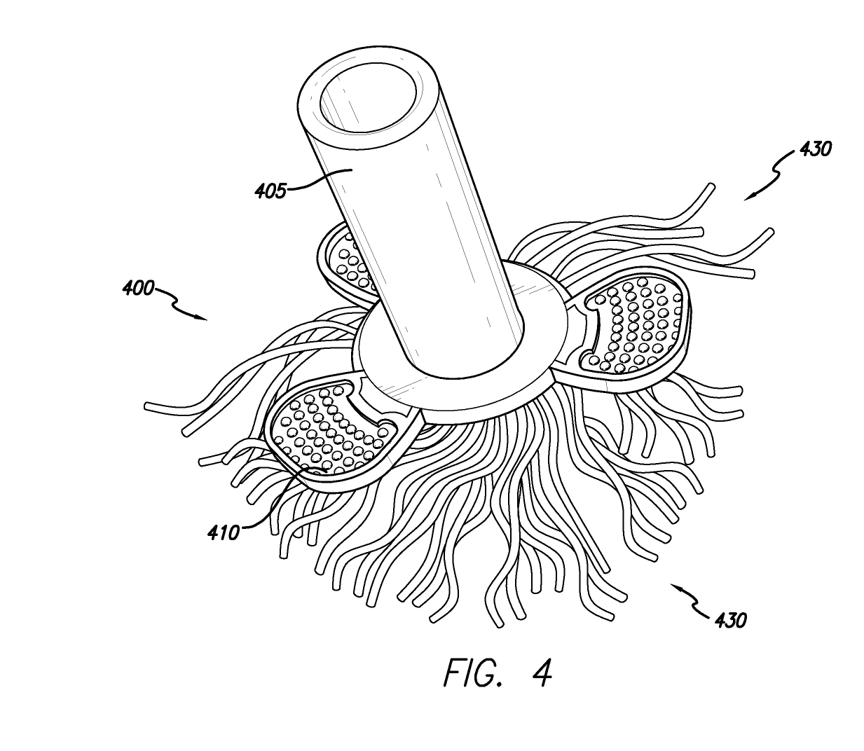

FIG. 4 is an illustration of the system, from a perspective view, while the mop handle is connected to the mop head, of various embodiments of the invention. A system for detachably connecting mop heads to mop handles 400 is illustrated along with its constituent parts, including the mop handle 405 and the mop head 410. Furthermore, the mop hairs 430 are illustrated, which attach to the body of the mop head 410.

1. (canceled)

2. (canceled)

3. (canceled)

4. (canceled)

5. (canceled)

6. (canceled)

7. (canceled)

8. (canceled)

9. (canceled)

10. A system for detachably connecting a mop head to a mop handle comprising:
a mop handle, said mop handle having a proximal end and a distal end, the proximal end of said mop handle comprising a ball joint,
said ball joint being generally spherical in shape and the diameter of said ball joint being greater than the diameter of said mop handle,
a mop head, said mop head comprising a pivot cup, said pivot cup featuring a depression that is configured to fit matingly with said ball joint, said depression being generally spherical in shape,
said mop head further comprising a body, said body being configured to attach mop hairs,
said mop head further comprising three reinforcing flanges, said reinforcing flanges protruding radially outward from said mop head,
said reinforcing flanges have a proximal end and a distal end, wherein said proximal end of said reinforcing flanges are attached to said mop head at an edge of said pivot cup, wherein said distal end of said reinforcing flanges are independently movable and are not attached to said body of said mop head,
wherein if any of said reinforcing flanges are pushed downward said edge of said pivot cup stretches to allow an easier detachment of said ball joint,
said ball joint is constructed from a material that is more rigid than the material from which said pivot cup is constructed,
such that, when said ball joint is connected to said pivot cup, said mop head is detachably connected to said mop handle.

11. A system for detachably connecting a mop head to a mop handle according to claim 10, wherein the mop head is constructed of on or more of the following: polyethylene (PE), polypropylene (PP), polystyrene (PS), acrylonitrile butadiene styrene (ABS), polyethylene terephthalate (PET), polyvinyl chloride (PVC), polyurthanes (PU), polycarbonate (PC), polyvinylidene chloride (PVDC), or other such plastic rubber materials as are known in the art.

12. A system for detachably connecting a mop head to a mop handle according to claim 10, wherein said mop head comprises a mop head selected from the following: broom heads, specialty mop heads, window squeegee heads, floor squeegee heads, window cleaner heads, floor sponge heads, window sponge heads, trowel heads, dustpan heads, dust mop heads, scraper heads, bulb changer heads, duster heads, feather duster heads, brush heads, or carpet sweeper heads.

13. A detachable mop device comprising:
a mop handle, said mop handle having a proximal end and a distal end, said proximal end of said mop handle comprising a ball joint; and
a mop head, wherein said mop head comprises a pivot cup, a plurality of reinforcing flanges, and a body;
wherein said pivot cup comprises an edge, a depression, and a bottom;
wherein said plurality reinforcing flanges have a proximal end and a distal end;
wherein said proximal end of said plurality reinforcing flanges are attached to said mop head at said edge of said pivot cup and said distal end of said plurality of reinforcing flanges protrude radially outward from said mop head;
wherein said distal end of said plurality of reinforcing flanges are independently movable and are not attached to said body of said mop head;
wherein said body of said mop head is below a bottom of said pivot cup;
wherein said depression of said pivot cup fits matingly with said ball joint;
wherein said mop handle and said mop head are connected by fitting said ball joint into said pivot cup such that said ball joint fits matingly with said pivot cup and said edge of said pivot cup holds said ball joint loosely in place;
wherein said mop handle and said mop head are detached by removing said ball joint from said pivot cup such that said edge of said pivot cup releases said ball joint; and
wherein said mop handle and said mop head are designed to withstand repeated connectings, detachings, and reconnectings.

14. The detachable mop device of claim 13, wherein said ball joint is generally spherical in shape and said pivot cup is generally spherical in shape;
wherein said ball joint is constructed from a material that is more rigid than the material from which said pivot cup is constructed; and
wherein when one or more of said plurality of reinforcing flanges are pushed downward said edge of said pivot cup stretches to allow easier detachment of said ball joint.

15. The detachable mop device of claim 14, wherein a diameter of said ball joint is greater than a cross sectional diameter of said mop handle.

16. The detachable mop device of claim 15, wherein said body of said mop head attaches to a plurality of mop hairs.

17. The detachable mop device of claim 16, wherein said mop handle is an extendible mop handle.

18. The detachable mop device of claim 17, wherein said mop head is made from a plastic rubber material.

19. The detachable mop device of claim 18, wherein said plurality of reinforcing flanges have a textured surface.
